(19) United States
(12) Patent Application Publication
(10) Pub. No.: US 2024/0119116 A1
(43) Pub. Date: Apr. 11, 2024

(54) IDENTIFICATION OF SEASONAL LENGTH FROM TIME SERIES DATA

(71) Applicant: International Business Machines Corporation, Armonk, NY (US)

(72) Inventors: David Alvra Wood, III, Scarsdale, NY (US); Petros Zerfos, New York, NY (US); Syed Yousaf Shah, Yorktown Heights, NY (US)

(21) Appl. No.: 18/179,413

(22) Filed: Mar. 7, 2023

(30) Foreign Application Priority Data
Oct. 11, 2022 (GR) 20220100835

(51) Int. Cl. G06F 17/18; G06Q 10/04

(52) U.S. Cl. CPC G06F 17/18; G06Q 10/04

(57) ABSTRACT

A method of detecting seasonality in time series data includes receiving a set of time series data, analyzing the time series data to generate a power spectrum, the power spectrum indicative of power as a function of frequency, and selecting a peak in the power spectrum, the selected peak having a peak power. The method also includes performing an interpolation around the selected peak, and selecting a number of additional peaks having powers within a selected proportion of the peak power. The method further includes, based on the number of additional peaks being less than a threshold number, identifying the selected peak as representing a season having a seasonal length, and determining a seasonal length of the season based on a frequency at the identified peak.

### BACKGROUND

Embodiments of the present invention relate to analysis of time series data, and more specifically, to identification of seasonality reflected in time series data.

Time series data has been increasingly used for a variety of applications, including natural sciences and economic applications. Seasonality may be determined by identifying periodic patterns in time series data, and is useful in many contexts. For example, analysis of time series data for seasonality is used in weather forecasting, economic forecasting and sales analysis. Accurate seasonality detection can be challenging, as time series data may have a large number of periodic patterns that may not be readily identifiable.

### SUMMARY

According to one or more embodiments of the present invention, a method of detecting seasonality in time series data includes receiving a set of time series data, analyzing the time series data to generate a power spectrum, the power spectrum indicative of power as a function of frequency, and selecting a peak in the power spectrum, the selected peak having a peak power. The method also includes performing an interpolation around the selected peak, and selecting a number of additional peaks having powers within a selected proportion of the peak power. The method further includes, based on the number of additional peaks being less than a threshold number, identifying the selected peak as representing a season having a seasonal length, and determining a seasonal length of the season based on a frequency at the identified peak.

According to one or more embodiments of the present invention, a system for detecting seasonality in time series data includes a memory communicatively coupled to a processor configured to perform operations. The operations include receiving a set of time series data, analyzing the time series data to generate a power spectrum, the power spectrum indicative of power as a function of frequency, and selecting a peak in the power spectrum, the selected peak having a peak power. The operations also include performing an interpolation around the selected peak, and selecting a number of additional peaks having powers within a selected proportion of the peak power. The operations further include, based on the number of additional peaks being less than a threshold number, identifying the selected peak as representing a season having a seasonal length, and determining a seasonal length of the season based on a frequency at the identified peak.

According to one or more embodiments of the present invention, a computer program product includes a storage medium readable by one or more processing circuits, the storage medium storing instructions executable by the one or more processing circuits to perform a method. The method includes receiving a set of time series data, analyzing the time series data to generate a power spectrum, the power spectrum indicative of power as a function of frequency, and selecting a peak in the power spectrum, the selected peak having a peak power. The method also includes performing an interpolation around the selected peak, and selecting a number of additional peaks having powers within a selected proportion of the peak power. The method further includes, based on the number of additional peaks being less than a threshold number, identifying the selected peak as representing a season having a seasonal length, and determining a seasonal length of the season based on a frequency at the identified peak.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 illustrates an embodiment of a computing environment, which is applicable to implement the embodiments of the present disclosure;

FIG. 2 is a block diagram depicting an embodiment of a method of determining seasonality in time series data, according to an exemplary embodiment;

FIG. 3A depicts an example of time series data;

FIG. 3B depicts the time series data of FIG. 3A after windowing;

FIG. 3C depicts the time series data of FIG. 3A after de-meaning and normalization;

FIG. 4A depicts an example of windowed time series data; and

FIG. 4B depicts an example of a power spectrum associated with the time series data of FIG. 4A.

### DETAILED DESCRIPTION

Systems, devices and methods are provided for analyzing time series data for identification and/or detection of seasonality. An embodiment of a method of identifying seasonal patterns includes transforming a set of time series into a frequency spectrum (e.g., via a Fourier transform such as a fast Fourier transform or FFT), and generating a power spectrum. The time series data may be pre-processed to remove edge frequencies due to windowing and/or padding to increase resolution.

One or more peaks in the power spectrum are determined, and the power spectrum is interpolated around each peak to increase the accuracy of determination of peak frequencies. One or more peaks are identified as a primary or dominant peak, and a frequency associated with each primary or dominant peak is identified as a dominant frequency corresponding to a seasonal length. In an embodiment, the interpolated power spectrum is further processed to increase the accuracy of seasonality detection. For example, harmonics of the primary frequencies are removed, and/or only peaks within a selected proportion of a highest magnitude or maximum dominant peak are identified as seasons.

Embodiments of the present invention described herein provide a number of advantages and technical effects. For example, embodiments provide for techniques to effectively identify seasonal patterns in time series data in a manner that is robust to noise and low frequency sampling, and identify seasonal patterns that may not be discernible using other methods.

Seasonality detection is challenging for a number of reasons. For example, time series data may have a large number of frequency peaks that may not be representative of seasonality, or multiple repeating patterns representing multiple seasons of various lengths. In addition, repeating patterns can have added characteristics such as increasing/decreasing slope, which makes seasonal peak detection more difficult. Embodiments described herein present a solution to the above problems.

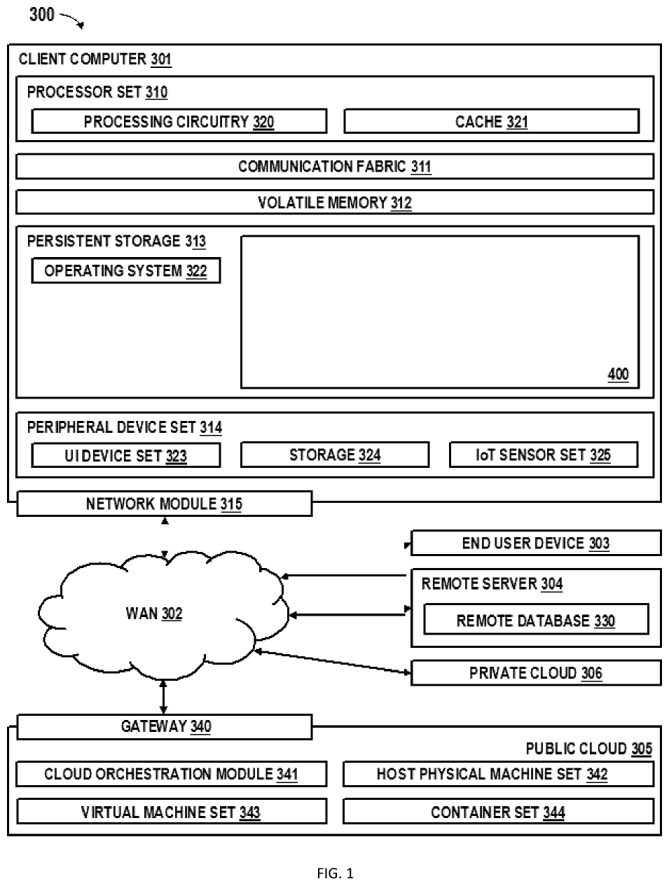

FIG. 1 depicts an example of a computing environment 300 for implementing the methods described herein. The computing environment 300 contains an example of an environment for the execution of at least some of the computer code involved in performing the inventive methods, such as seasonality detection code 400. In addition to block 400, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 400, as identified above), peripheral device set 314 (including user interface (UI), device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 1. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 400 in persistent storage 313.

COMMUNICATION FABRIC 311 is the signal conduction paths that allow the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, the volatile memory is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface type operating systems that employ a kernel. The code included in block 400 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

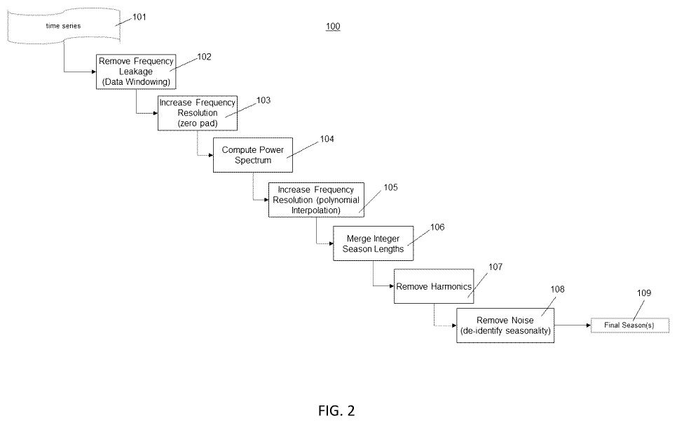

FIG. 2 illustrates aspects of an embodiment of a computer-implemented method 100 of detecting seasonality from time series data. The method 100 may be performed by a processor or processors, such as processing components of the computing environment 300, but is not so limited. It is noted that aspects of the method 100 may be performed by any suitable processing device or system.

The method 100 includes a plurality of stages or steps represented by blocks 101-109, all of which can be performed sequentially. However, in some embodiments, one or more of the stages can be performed in a different order than that shown or fewer than all of the stages shown may be performed.

At block 101, a set of time series data is acquired. For example, time series data is stored or transmitted to a memory such as the memory 34. Time series data may be accessed from a remote location, such as a time series database (e.g., via the network 36, which may be a cloud computing network or other network). The time series data may be normalized to remove linear trends and offsets present in the data.

At blocks 102 and 103, the time series data may be pre-processed to facilitate seasonality detection. Such pre-processing can improve the resolution of detected frequencies and/or remove extraneous frequencies not associated with seasonality.

At block 102, data windowing is performed to prevent frequency leakage. The acquired time series data is typically taken from a larger set of data by windowing to generate a segment of the larger set (referred to an initial windowing). Frequency leakage can occur when applying a Fourier transform due to abrupt signal changes at the edges of the windowed time series data. Frequency leakage causes a blurring of the frequencies.

To prevent frequency leakage, a second window function is applied to the edges of the windowed time series data to smooth the data at window boundaries. For example, a Hamming window or a Hanning window is applied around the edges for smoothing.

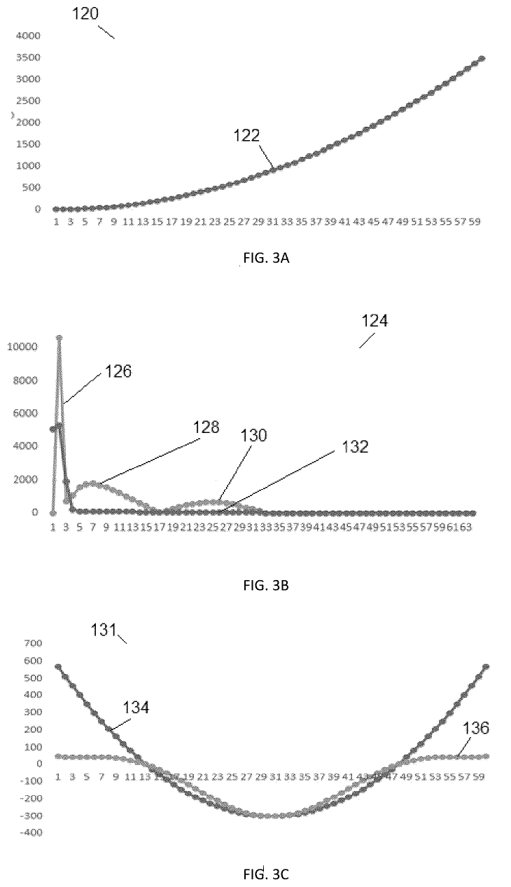

FIGS. 3A-3C depict an example of a set of time series data and results of windowing to prevent frequency leakage. FIG. 3A is a graph 120 of time series data showing sampled signal values as a function of sample number. The time series data is shown as a curve 122. FIG. 3B is a graph 124 that shows the time series data after initial windowing (curve 126). As shown in curve 126 the initial windowing causes signal changes (peaks 128 and 130) at an edge of the initial window. Applying a Hamming window around the edge removes the signal changes, as shown by curve 132. FIG. 3C depicts a graph 131 that shows the time series data after de-meaning and normalization, prior to windowing (curve 134) and after windowing (curve 136).

At block 103, zero padding is added to ends of the time series data (or segment), in order to increase frequency resolution. In an embodiment, the time series data is padded to more than the next power of 2 above the number of samples in the time series data. For example, the time series data is padded to 16x the next power of 2 above the number of samples.

At block 104, the time series data (optionally after padding) is transformed into a frequency spectrum via a Fourier transform, such as a fast Fourier transform (FFT). The frequency spectrum is then used to compute a power spectrum.

At block 105, frequency resolution is increased by performing an interpolation on the power spectrum. Spectrum analysis is performed to determine the maximum power across the entire power spectrum (ignoring the DC component) and select one or more peaks in the power spectrum (e.g., peaks having a magnitude above a selected threshold power). The power spectrum is interpolated around each selected peak in order to provide an improved estimate of signal frequencies having the highest powers (referred to as dominant or primary frequencies). Interpolation may be, for example, polynomial interpolation or spline interpolation.

If there are multiple peaks above the threshold, in an embodiment, at least the peak associated with the lowest frequency is selected. In some cases, there may be multiple peaks selected as potential dominant peaks corresponding to potential seasons.

At block 106, for each selected peak, the corresponding frequency is determined, and similar frequencies (representing the same or similar season length) are merged into a single frequency peak. This step results in a single frequency (primary or dominant frequency) representing the closest frequency group, and thereby makes identification of the strongest frequency signals easier to identify.

As noted above, the power spectrum can reveal more than one potential dominant frequency, which would be indicative of multiple seasons or seasonal lengths. For example, there may be multiple power spectrum peaks above some threshold power. In such cases, the merging may be performed for each peak selected at block 105.

At block 107, frequency peaks in the power spectrum that are harmonics of a frequency of a selected peak are removed. This reduces the number of season lengths so that only primary season lengths are identified, which facilitates noise removal (block 108).

The power spectrum is analyzed to identify frequencies that are integer multiples of the of a selected peak (i.e., are harmonics), and have peaks that are below or near the magnitude of the selected peak. Such frequencies are identified as harmonics and removed from consideration.

After harmonics removal, one or more of the selected peaks are identified as representing a season. The seasonal length of each season corresponds to the frequency of the corresponding identified peaks.

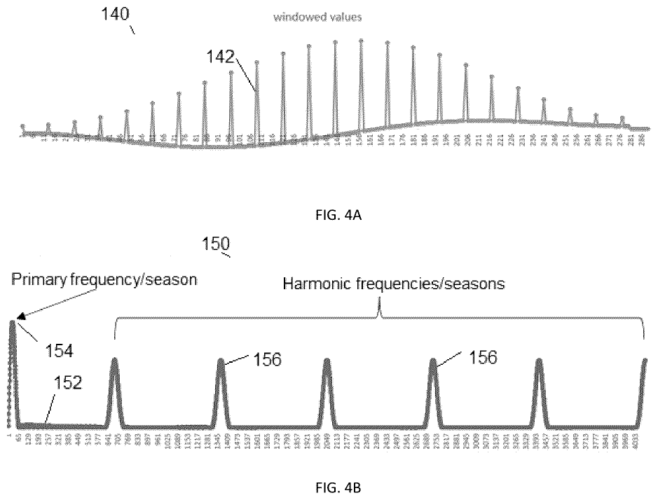

FIGS. 4A and 4B show an example of windowed time series data and a computed power spectrum. Specifically, FIG. 4A is a graph 140 of time series data including windowed values (curve 142). FIG. 4B is a graph 150 of the computed power spectrum (curve 152). The lowest peak 154 in the power spectrum is identified as a primary or dominant frequency. The power spectrum also includes multiple harmonic peaks 156 at integer multiples of the dominant frequency. These peaks are removed at block 107.

At block 108, in an embodiment, identification of peaks is based on the number and magnitude of all of the peaks selected as discussed above. For example, each selected peak (e.g., after harmonics removal and merging) above a threshold is identified as a dominant peak associated with a season. In another example, given a power spectrum having a plurality of selected peaks, the selected peak having the highest power is determined, and only the peaks having magnitudes within a selected proportion (e.g., about 25%) of the highest power are selected as seasons.

In some cases, if there are too many peaks (e.g., due to noisy signals or signals without clear seasonality), selection of all of the peaks could result in compromised forecasting accuracy. Accordingly, in an embodiment, if the number of selected peaks is greater than a selected number (e.g., 4), the method 100 ends without declaring any seasonality. In another embodiment, seasonality is not declared if all the selected peaks represent a selected percentage (e.g., about 12.5%) of the total energy.

At block 109, each frequency associated with a primary or dominant peak (primary or dominant frequency) is associated with a season and seasonal length. The seasonal lengths may be input into a forecasting model or other application. Examples of forecasting models include state space models, Holt-Winters models, Damped Holt-Winters models, environmental models (e.g., climate modes, weather models, ocean models such as the Bermuda Atlantic Time-Series or BATs, economic forecast models, and others). In addition, seasonal lengths can be input to artificial intelligence models (e.g., as estimations of lookback windows used by machine learning (ML) and deep learning (DL) models).

The present techniques may be implemented as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to aspects of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method of detecting seasonality in time series data, the method comprising:
receiving a set of time series data;
analyzing the time series data to generate a power spectrum, the power spectrum indicative of power as a function of frequency;
selecting a peak in the power spectrum, the selected peak having a peak power;
performing an interpolation around the selected peak;
selecting a number of additional peaks having powers within a selected proportion of the peak power;
based on the number of additional peaks being less than a threshold number, identifying the selected peak as representing a season having a seasonal length; and
determining a seasonal length of the season based on a frequency at the identified peak.

2. The method of claim 1, wherein the interpolation is selected from spline interpolation and polynomial interpolation.

3. The method of claim 1, wherein the analyzing includes performing a Fourier transform to generate a frequency spectrum, the power spectrum generated based on the frequency spectrum.

4. The method of claim 3, wherein the analyzing includes pre-processing the time series data prior to performing the Fourier transform by applying a windowing function to prevent frequency leakage.

5. The method of claim 4, wherein the windowing function is selected from a Hamming window and a Hanning window.

6. The method of claim 4, wherein the pre-processing includes padding the time series data to increase frequency resolution.

7. The method of claim 1, further comprising merging one or more frequencies in the interpolated power spectrum, the one or more frequencies associated with a same seasonal length, and removing harmonic frequencies that are an integer multiple of the identified peak.

8. The method of claim 1, further comprising, based on the number of additional peaks being greater than the threshold number, indicating that the time series data lacks significant seasonality.

9. The method of claim 1, further comprising inputting the seasonal length into a time series forecasting model.

10. A system for detecting seasonality in time series data, the system comprising a memory communicatively coupled to a processor, where the processor is configured to perform operations comprising:
receiving a set of time series data;
analyzing the time series data to generate a power spectrum, the power spectrum indicative of power as a function of frequency;
selecting a peak in the power spectrum, the selected peak having a peak power;
performing an interpolation around the selected peak;
selecting a number of additional peaks having powers within a selected proportion of the peak power;
based on the number of additional peaks being less than a threshold number, identifying the selected peak as representing a season having a seasonal length; and
determining a seasonal length of the season based on a frequency at the identified peak.

11. The system of claim 10, wherein the analyzing includes performing a Fourier transform to generate a frequency spectrum, the power spectrum generated based on the frequency spectrum.

12. The system of claim 11, wherein the analyzing includes pre-processing the time series data prior to performing the Fourier transform by applying a windowing function to prevent frequency leakage.

13. The system of claim 12, wherein the pre-processing includes padding the time series data to increase frequency resolution.

14. The system of claim 10, wherein the operations further comprise merging one or more frequencies in the interpolated power spectrum, the one or more frequencies associated with a same seasonal length, and removing harmonic frequencies that are an integer multiple of the identified peak.

15. The system of claim 10, wherein the operations further comprise, based on the number of additional peaks being greater than the threshold number, outputting an indication that the time series data lacks significant seasonality.

16. A computer program product comprising a storage medium readable by one or more processing circuits, the storage medium storing instructions executable by the one or more processing circuits to perform a method comprising:
receiving a set of time series data;
analyzing the time series data to generate a power spectrum, the power spectrum indicative of power as a function of frequency;
selecting a peak in the power spectrum, the selected peak having a peak power;
performing an interpolation around the selected peak;
selecting a number of additional peaks having powers within a selected proportion of the peak power;
based on the number of additional peaks being less than a threshold number, identifying the selected peak as representing a season having a seasonal length; and
determining a seasonal length of the season based on a frequency at the identified peak.

17. The computer program product of claim 16, wherein the analyzing includes performing a Fourier transform to generate a frequency spectrum, the power spectrum generated based on the frequency spectrum.

18. The computer program product of claim 17, wherein the analyzing includes pre-processing the time series data prior to performing the Fourier transform by applying a windowing to prevent frequency leakage.

19. The computer program product of claim 18, wherein the pre-processing includes padding the time series data to increase frequency resolution.

20. The computer program product of claim 16, wherein the method further comprises merging one or more frequencies in the interpolated power spectrum, the one or more frequencies associated with a same seasonal length, and removing harmonic frequencies that are an integer multiple of the identified peak.
